(19) United States
(12) Patent Application Publication
(10) Pub. No.: US 2004/0026021 A1
(43) Pub. Date: Feb. 12, 2004

(54) Method of manufacturing a metal-reinforced plastic panel

(76) Inventors: A. Anthony Groh, Columbus, OH (US); John P. Frechette, Powell, OH (US); Kevin T. Burt, Columbus, OH (US); Matthew T. Fenneman, Gahanna, OH (US)

Correspondence Address: STANDLEY LAW GROUP LLP, 495 METRO PLACE SOUTH, SUITE 210, DUBLIN, OH, 43017, US

(21) Appl. No.: 10/452,612

(22) Filed: Jun. 2, 2003

Related U.S. Application Data
(60) Provisional application No. 60/385,430, filed on May 31, 2002.
(60) Provisional application No. 60/450,415, filed on Feb. 27, 2003.

(51) Int. Cl. B29C 47/02

(52) U.S. Cl. 156/244.12; 156/244.24

(57) ABSTRACT

A composite panel comprised of a sheet of substrate and a coextruded layer of plastic covering the substrate. The panel may be used as a retaining panel for a body of water in a cantilever wall or an anchored sheet pile wall. The retaining panel may include a central portion, two side portions, and two flanges. The retaining panel may also include integral connecting portions. The substrate may be comprised of a material such as aluminum or steel, while the plastic may be a material such as polyvinyl chloride (PVC). Other applications of the composite panel include uses as building panels for sidewalls or roofs.

This application claims the benefit of U.S. Provisional Application No. 60/385,430, filed May 31, 2002, and U.S. Provisional Application No. 60/450,415, filed Feb. 27, 2003, each of which is hereby incorporated by reference in its entirety.

### BACKGROUND AND SUMMARY OF THE INVENTION

The present invention relates generally to a retaining panel for a body of water and, more particularly, to a retaining panel that may protect against a bounding shore with its top preferably extending above ground level and its bottom preferably anchored down into the ground below the water bottom. An exemplary embodiment of a retaining panel of the present invention may be adapted for use as a seawall, a ground erosion barrier, a barrier against land erosion caused by waterways such as rivers, streams, ponds, lakes, seas, and oceans, a shoreline bulkhead, a wave breaker, a retaining wall, a footbridge, or as a panel in a wall structure for any other suitable use. A retaining panel of the present invention may be made from a variety of materials using a variety of techniques which will become apparent to one of ordinary skill in the art upon reading this disclosure. For example, a retaining panel of the present invention may be comprised of extruded plastic and metal or other similar or suitable materials.

Over the years, there has existed the problem of land erosion caused by waterways such as rivers, streams, ponds, lakes, seas, and oceans. In order to limit and/or prevent land erosion adjacent these waterways, it is known to provide a series of seawall panels that are laterally aligned, interconnected, and anchored into the ground so as to provide a barrier against a waterway. The seawall panels may be subjected to enormous pressures and loads which, if forceful enough, may ultimately break the connection between adjacent seawall panels. Consequently, the barrier may become less effective over time, and individual seawall panels may have to be repaired or replaced. This may be expensive, and it may require the use of special heavy construction equipment. In light of the costs of repairing barriers made from seawall panels, a need exists for seawall panels that are better adapted to endure various pressures and loads.

The loads governing the design of a seawall arise primarily from the soil and water surrounding the wall and other influences such as surface surcharges and external loads applied directly to the wall panels. For example, the seawall is exposed to earth pressures reflecting the state of stress in the soil mass. Such earth pressures include static pressures generated by the lateral pressure that is imposed on a wall due to the weight of the soil supported by the wall. In addition, pressures are generated when a wall moves or rotates away from the soil allowing the soil to expand horizontally in the direction of the wall or conversely, horizontal pressures develop when a wall moves or rotates toward the soil that tends to compress the soil horizontally. An additional component of force on a seawall is generated by friction and adhesion between the wall and the soil that cause shearing stresses that have an effect on the magnitude of the horizontal forces imposed on the wall.

Additional loads on a seawall include surcharge loads which are forces generated by stockpiled material, machinery, roadways, and other influences resting on the soil surface in the vicinity of the wall that increase the lateral pressures on the wall. In addition, water loads on the wall include hydrostatic pressure due to a difference in water level on either side of the wall that creates an unbalanced hydrostatic pressure; seepage related pressures due to the movement of water around or through the wall; and wave action producing lateral forces on the wall. Other forces imposed upon a seawall that must be a factor in its design include forces generated due to undesired impacts, mooring points, ice formation, wind, and earthquakes.

Seawalls are typically made from steel, wood, concrete, aluminum, fiberglass, or plastic. Each of these materials has disadvantages when used for a seawall application. Steel is the most common material used for walls due to its inherent strength and long service life. Sometimes the steel wall material develops a patina that inhibits further corrosion of the steel material. However, the typical steel seawall is subject to corrosion that is highly dependent on the environment in which the wall is placed. In marine environments, the rate of corrosion is related to the type of water to which the steel is exposed. Typically, fresh water is the least corrosive and salt water is the most corrosive, with contaminants and pollutants playing a major role in magnifying its corrosiveness.

The most common way to protect a steel wall is through the use of coatings. Generally, after the installation of the steel wall, a coal tar epoxy is applied to the steel wall surface in the vicinity of the top of the earthen fill where it contacts the wall surface. Additional epoxy coverage is applied below and above the fill line. On the side of the wall exposed to water, it is critical to spread the epoxy in at least the vicinity of the splash zone defined as the area between the still water elevation and the upper limit of wave action. Cathodic protection is another effective method of protecting steel walls. In some cases, a thicker steel wall may be specified to provide for anticipated loss of material resulting from corrosion.

Seawalls made from a plastic material are becoming more common for specific uses. Exterior-grade vinyl panels provide impervious barriers to salt water, sun damage, rot, rust, and marine borers. However, the plastic wall lacks the structural strength compared to a steel wall of like dimension. As a result, the plastic wall may sometimes be designated for installations requiring lower structural capacities as compared to steel. In addition, an anchored plastic wall will require additional anchors and wales as compared to a similarly sized steel wall counterpart. As a result, additional installation labor and materials are required for the anchored plastic wall.

An embodiment of the present invention provides a seawall panel that combines the inherent structural strength of a steel wall and the inherent corrosion resistant properties of the plastic wall. The present invention provides a composite panel that is comprised of at least one sheet of a metal substrate and a coextruded layer of plastic covering some or all sides of the metal substrate. The composite panel may be shaped by roll forming, cold forming, or hydro forming to a desired cross-sectional profile. Certain cross-sectional profiles may increase the structural strength of the installed panel to resist the loads such as those described above. For example, a wall comprised of corrugated panels is better able to support the loads placed upon the wall as discussed above when compared to a wall comprised of flat panels of like thickness.

In addition, an exemplary panel of the present invention may additionally be comprised of connecting portions on one or both ends of the composite panel. As a result, adjacent panels can be interlocked to extend the length of a wall section comprised of panels of the present invention. It is preferable that such connecting portions are water-tight, simplify installation of the wall panels, and provide structural strength to the assembled wall. Examples of such connecting portions may be generally described as male and female interlocking connections that may be installed on opposite ends of a given panel to simplify the installation of adjacent wall panels. Another example of the connecting portions may be described as interlocking C-shaped and T-shaped portions.

An exemplary panel of the present invention may be connected to additional like panels to form a seawall known as a cantilever wall. The cantilever wall is a wall that derives its support solely from being driven into the foundation soil. Since a seawall panel embodiment of the present invention is able to provide inherent structural strength due to the presence of the metal substrate, it is better suited for the cantilever wall application as compared to a like sized plastic wall. In addition to superior strength, the seawall panel embodiment of the present invention provides superior corrosion resistance as compared to a similar steel wall.

An exemplary panel of the present invention may be connected to additional like panels to form another type of seawall. Other names for structures similar to this seawall include sheet pile wall and anchored wall. A sheet pile wall made from the present invention would be comprised of interlocking vertical wall panels or pile segments driven to form the wall. An anchored wall is a sheet pile wall that derives its support form a combination of the wall panels being driven into the soil and from anchors that are set into adjacent soil or rock to generate an anchoring force to assist in the support of the wall. The anchoring force is typically transmitted to the wall by tie rods extending from the anchor to the wall. The tie rods are typically placed into contact with the wall panels by horizontal beams called wales to transfer and distribute the anchor force from the tie rod to the wall.

The present invention also describes a top cap that may be used in conjunction with a composite panel as described as an exemplary embodiment above to make a new system of constructing seawalls or anchored sheet pile walls. The top cap takes advantage of the inherent structural strength of steel and the corrosion resistance of plastic in its form as an essentially U-shaped member made from at least one sheet of metal substrate that has a coextruded plastic covering on some or all sides of the substrate. The top cap may serve as the cover for the upper end of a seawall and the connection point for a tie rod that is in turn connected to an anchor point. The new system of seawall construction takes advantage of the inherent strength of the metal substrate, such as steel, that would comprise an example embodiment of the wall panel. The new wall system allows an anchored seawall to derive its anchoring support from a plurality of anchors and tie rods connected to the seawall panels solely at the upper end of the panels where the top cap has been placed to cover and support the seawall panels.

In contrast to a similarly sized plastic seawall, an embodiment of the system of seawall construction as described by the present invention may require fewer anchors and allow the tie rods to be connected exclusively near the upper end of the seawall panels. As a result, installation labor and material costs may be decreased. In addition, the integrity of the wall is enhanced since none of the wall panels have to be penetrated below the upper end where the top cap has been installed. As a result, the new system of seawall construction is less reliant on sealers, o-rings, grommets, or other similar sealing means that would be required to seal around the penetrations in the wall panels that are made for the installation of tie rods and wales providing mid-panel support for the plastic seawall structure. In addition to reduced installation labor and material costs, the new system of seawall construction of the present invention would not require maintenance of the mid-panel support over the useful life of the structure.

An exemplary embodiment of the retaining panel is comprised of at least one sheet of metal substrate and a coextruded layer of plastic covering some or all sides of the sheet(s) of metal substrate. The retaining panel may be roll formed to a make a desired cross-sectional shape that will be capable of withstanding the tremendous forces from the soil load and hydraulic forces placed upon the retaining wall. Each retaining panel, once formed, may be of one-piece construction. The central portion has a first end and a second end. The first side portion is integrally connected to and extends rearwardly at a first angle from the first end of the central portion. Similarly, the second side portion is integrally connected to and extends rearwardly at a second angle from the second end of the central portion. The first flange is integrally connected to and extends from a rear end of the first side portion, and the second flange is integrally connected to and extends from a rear end of the second side portion. Each of the flanges has a proximal portion and a distal portion. The distal portion of the first flange defines a female connecting portion, and the distal portion of the second flange defines a male connecting portion. As a result, the retaining panel is preferably adapted to be connected to a substantially similar, adjacent retaining panel by inserting its male connecting portion into the female connecting portion of the adjacent retaining panel. A retaining panel may be adapted to be interlocked with the adjacent retaining panel by inserting the male connecting portion of the retaining panel into the female connecting portion of the adjacent retaining panel.

The first angle and the second angle may be approximately equal. The lengths of the first and second side portions may be approximately equal. The first flange may extend from the first side portion at a third angle, and the second flange may extend from the second side portion at a fourth angle. The third and fourth angles are preferably about equal. The central portion may be approximately parallel to the proximal portions of the first flange and the second flange.

An exemplary embodiment of a retaining panel of the present invention may have a substantially uniform thickness. It should be recognized, however, that the thickness of a retaining panel of the present invention may vary. An intermediate portion of the central portion may have a substantially level outer surface approximately between the first end and the second end. Similarly, an intermediate portion of the first side portion may have a substantially level outer surface approximately between the first end of the central portion and the rear end of the first side portion, and an intermediate portion of the second side portion may have a substantially level outer surface approximately between the second end of the central portion and the rear end of the second side portion. Moreover, the proximal portion of the first flange may have a substantially level outer surface approximately between the rear end of the first side portion and the distal portion of the first flange, and the proximal portion of the second flange may have a substantially level outer surface approximately between the rear end of the second side portion and the distal portion of the second flange.

A retaining panel of the present invention may be made from a variety of materials. For example, the metal substrate of the present invention may be made from various metal alloys providing the required strength to serve as a retaining wall for the desired application. Steel, including carbon steel and stainless steel, as well as aluminum may comprise the metal substrate of the present invention. An exemplary embodiment of a retaining panel of the present invention is comprised of at least one sheet of steel substrate that is about 0.06 inches thick and about 17.5 inches wide. In other embodiments of the present invention, the metal substrate may be more or less than 0.06 inches thick and more or less than 17.5 inches wide.

Thermoplastics such as polyethylene comprise a suitable material for the coextruded layer of plastic of the present invention. Other plastics such as polyvinyl chloride (PVC) or a polyolefin may also comprise the plastic material used for the coextruded layer of plastic claimed in the present invention. A coextruded layer of PVC may cover all sides of the sheet of steel of an exemplary embodiment. The plastic may also include additives including, but not limited to, stabilizers, process aids, lubricants, modifiers, etc. Embodiments of the present invention may also use a plastic comprised of inorganic components or cellulosic filler. The plastic layer preferably prevents and/or withstands heat, cold, pressure exerted by the water, pressure exerted by the land, corrosion, and deterioration by sunlight. In addition, conventional extrusion or molding processes may be utilized to make the coextruded plastic portion of the retaining panel of the present invention from a plastic material.

The combination of a metal substrate and a coextruded plastic layer also preferably makes a retaining panel of the present invention relatively lightweight, easy to install, and easy to repair or replace, while being strong and durable. In addition to the seawall embodiments discussed above, examples of the present invention have other marine applications such as building components including siding or roof panels. The present invention may be used in other applications where a building panel is exposed to a harsh or corrosive environment. The present invention can be used to form various components of a dock or a deck. The present invention is suitable for use as a retaining wall in a non-marine environment. An embodiment of the present invention may be used to provide a plastic coated structural component for office or shop equipment.

In addition to the novel features and advantages mentioned above, other objects and advantages of the present invention will be readily apparent from the following descriptions of the drawings and exemplary embodiments.

### BRIEF DESCRIPTION OF THE DRAWINGS

FIG. 1 is a cross-sectional view of an exemplary embodiment of a retaining panel of the present invention.

FIG. 2 is a cross-sectional view of another exemplary embodiment of a retaining panel of the present invention.

FIG. 3 is a cross-sectional view of an exemplary embodiment of a cap of the present invention.

FIG. 4 is a cross-sectional view of an exemplary embodiment of an installation that may utilize an exemplary embodiment of a retaining panel of the present invention.

FIG. 5 is a cross-sectional view of an exemplary embodiment of an installation that may utilize an exemplary embodiment of a retaining panel of the present invention.

FIG. 6 is a top perspective view of the retaining panel of FIGS. 1 or 2.

FIG. 7 is a bottom perspective view of the retaining panel of FIGS. 1 or 2.

FIG. 8 is a top plan view of the retaining panel of FIGS. 1 or 2.

FIG. 9 is a bottom plan view of the retaining panel of FIGS. 1 or 2.

FIG. 10 is a left side elevational view of the retaining panel of FIGS. 1 or 2.

FIG. 11 is a right side elevational view of the retaining panel of FIGS. 1 or 2.

FIG. 12 shows an extruder and a cross-head die of an exemplary extrusion system.

### DETAILED DESCRIPTION OF EXEMPLARY EMBODIMENT(S)

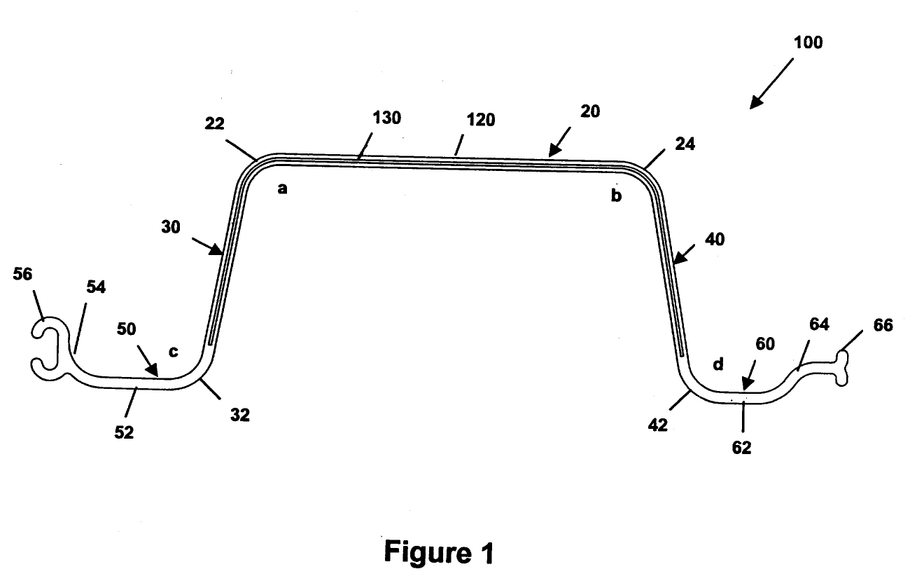

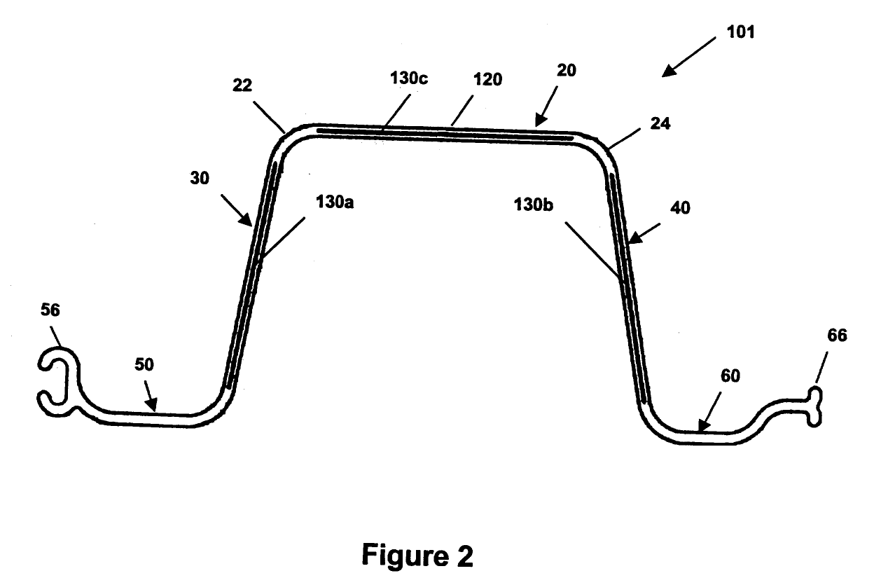

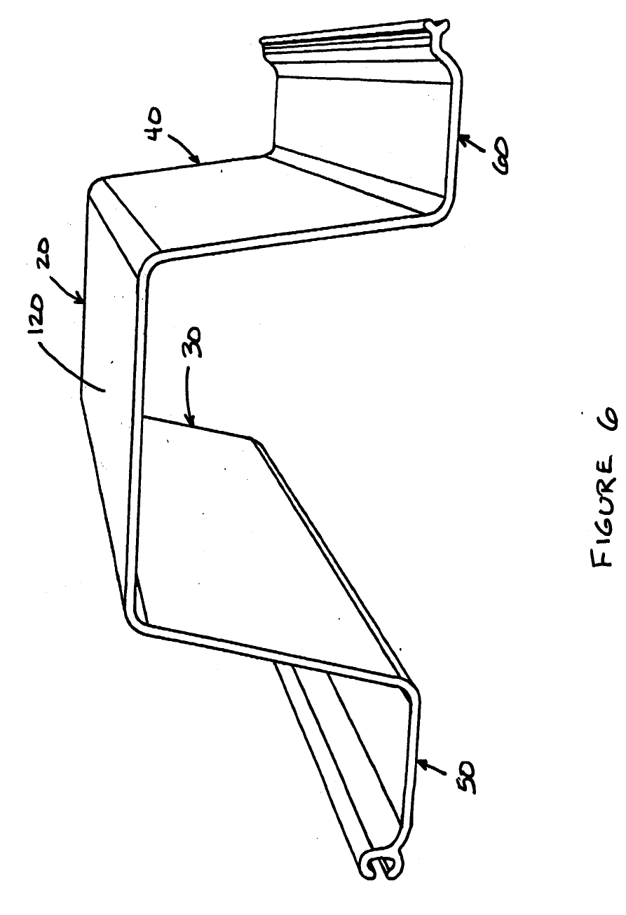

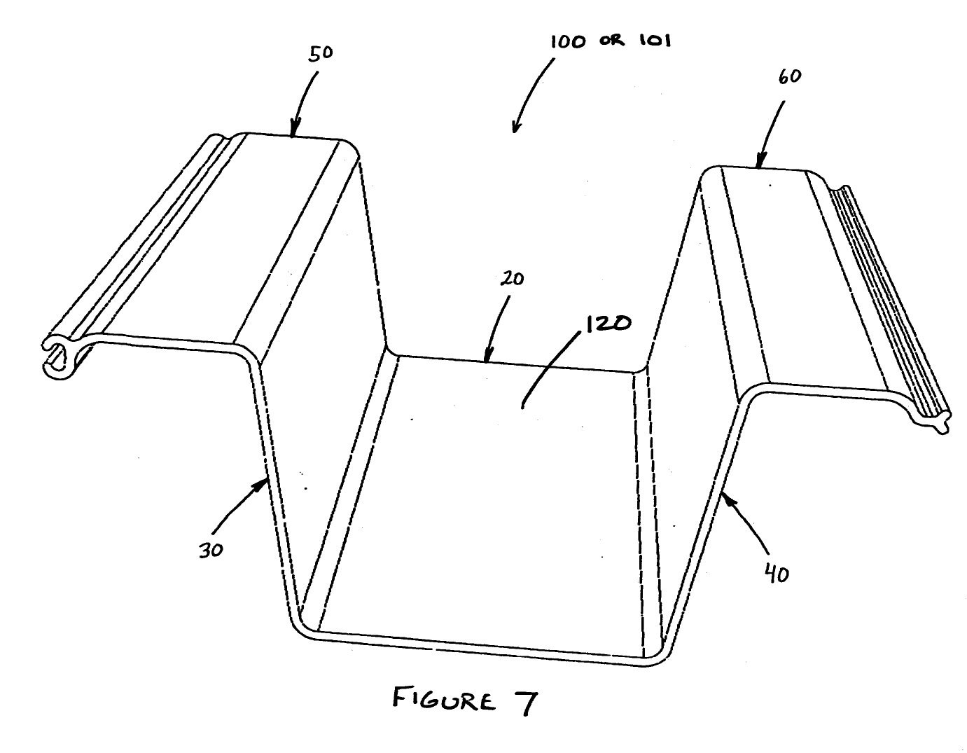

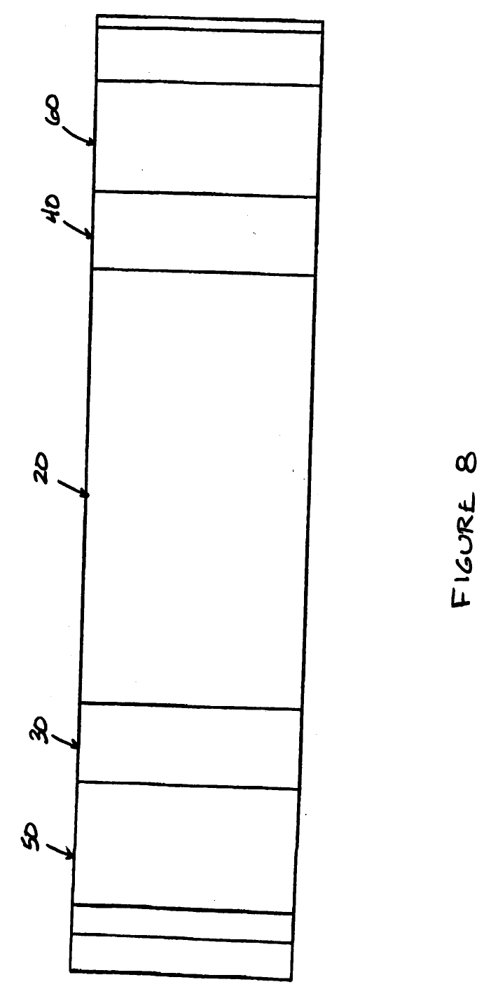

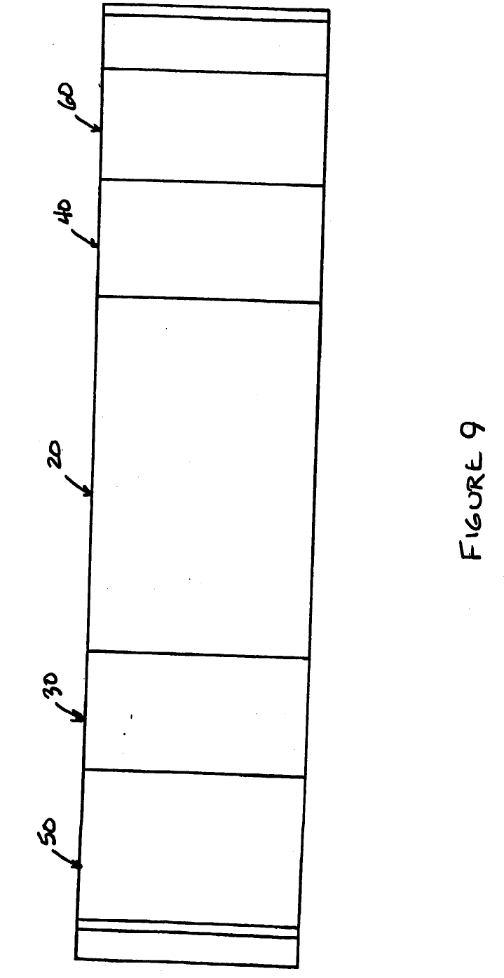

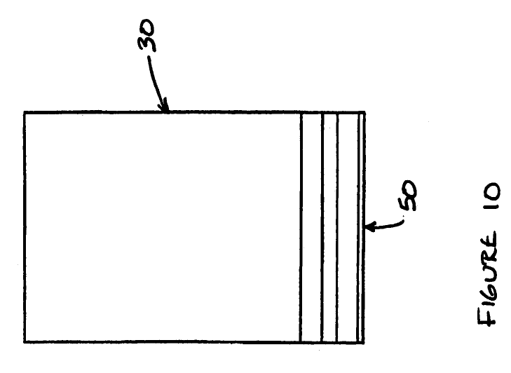

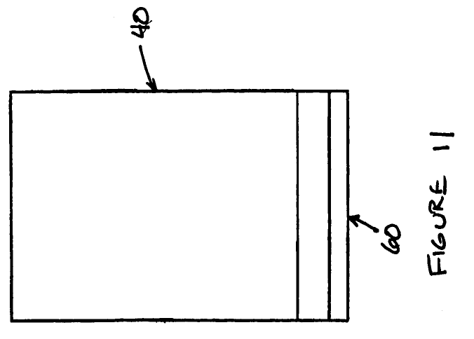

The present invention is directed to a retaining panel that may protect against a bounding shore with its top preferably extending above ground level and its bottom preferably anchored down into the ground below the water bottom. FIGS. 1 and 2 illustrate cross-sectional views of two exemplary embodiments of a retaining panel of the present invention. FIGS. 6 through 11 illustrate various perspective, plan, and elevational views of the exemplary embodiments shown in FIGS. 1 and 2. The retaining panel 100 includes a sheet of metal substrate 130, a coextruded layer of plastic 120, a central portion 20, a first side portion 30, a second side portion 40, a first flange 50, and a second flange 60. As shown in these figures, the retaining panel 100 is preferably of one-piece construction for maximum durability and longevity. A one-piece construction preferably eliminates unnecessary joints which may eventually fail under the pressures and loads in the field. In fact, the inventors have discovered that the metal reinforced panel further enhances the structural characteristics of a wide body panel, such as a panel having a width of at least about 24 inches. However, it should be recognized that the reinforced panel also improves the structural characteristics of a panel having a width less than 24 inches.

As shown in FIG. 1, the sheet of metal substrate 130 of the retaining panel 100 may be continuous through a portion of the entire retaining panel. As shown in FIG. 2, the sheets of metal substrate 130a, 130b, and 130c of the retaining panel 101 may be discontinuous through the retaining panel. An exemplary metal used for the sheets of metal substrate 130 (FIG. 1) or 130a, 130b, and 130c (FIG. 2) may be comprised of steel, such as carbon steel or stainless steel, aluminum, or other similar suitable metals. The coextruded layer of plastic 120 of the retaining panels 100 and 101 may preferably be continuous around the sheets of metal substrate 130 or 130a, 130b, and 130c of the retaining panels at 100 or 101, respectively. The coextruded layer of plastic 120 may preferably be comprised of a durable and lightweight material such as polyvinyl chloride (PVC), polyethylene, polypropylene, or other similar, suitable, or conventional materials. This combination of the sheet of metal substrate 130 or 130a, 130b, and 130c and the coextruded layer of plastic 120 provides a strong, durable, and lightweight retaining panel 100 or 101 as exemplary embodiments of the present invention.

With regard to FIG. 1, the central portion 20 of the retaining panel 100 has a first end 22 and a second end 24. The first side portion 30 is integrally connected to and extends at an angle a from the first end 22. Similarly, the second side portion 40 is integrally connected to and extends at an angle b from the second end 24. The length of the first side portion 30 is preferably about equal to the length of the second side portion 40, and the angle a is preferably about equal to the angle b. However, the length of the first side portion 30 may be different than the length of the second side portion 40, and the angle a may be different than the angle b. For instance, the aforementioned angles and lengths may vary to enable interconnected retaining panels to conform to the shape of the land.

The first flange 50 is integrally connected to and extends from a rear end 32 of the first side portion 30, and the second flange 60 is integrally connected to and extends from a rear end 42 of the second side portion 40. The first flange 50 extends from the first side portion 30 at an angle c, and the second flange 60 extends from the second side portion 40 at an angle d. The angle c is preferably about equal to the angle d. However, it should be recognized that the angle c may vary from the angle d. For example, the angle c may be different than the angle d so that adjacent retaining panels may be interconnected as will be explained hereinafter.

The first flange 50 has a proximal portion 52 and a distal portion 54. Similarly, the second flange 60 has a proximal portion 62 and a distal portion 64. The distal portion 54 defines a female connecting portion 56, and the distal portion 64 defines a male connecting portion 66. As a result, the retaining panel 100 is preferably adapted to be connected to a substantially similar, adjacent retaining panel 100 by inserting its male connecting portion 66 into the female connecting portion 56 of the adjacent retaining panel 100. The female connecting portion 56 and the male connecting portion 66 may enable the retaining panel 100 to be interlocked with the retaining panel 100. Those skilled in the art should recognize that the distal portions 54, 64 may be of various shapes. In an exemplary embodiment, the distal portion 54 defining the female connecting portion 56 may be substantially C-shaped and the distal portion 64 defining the male connecting portion 66 may be substantially T-shaped.

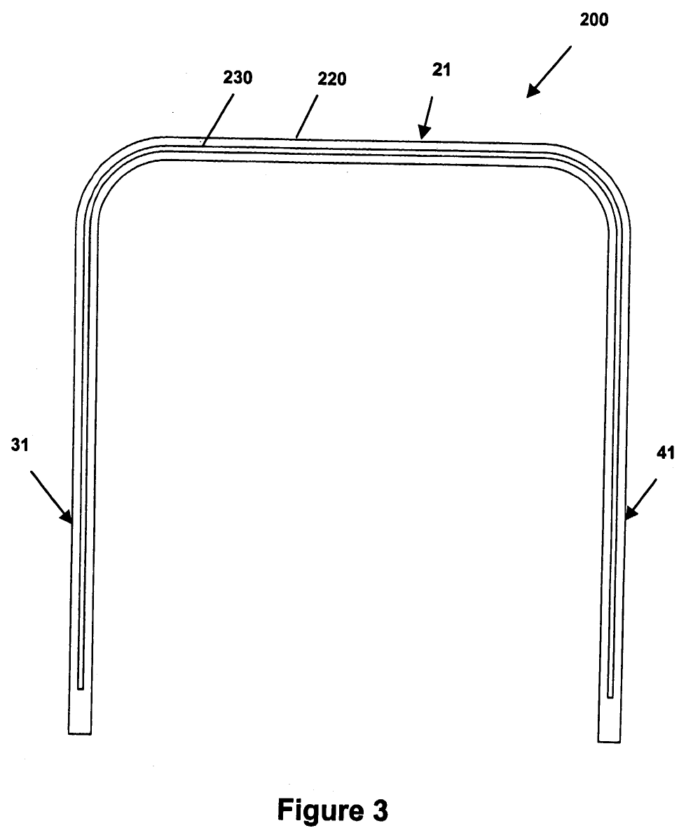

FIG. 3 shows a cross-sectional view of an exemplary embodiment of a cap of the present invention. The cap 200 includes a sheet of metal substrate 230, a coextruded layer of plastic 220, a top portion 21, a first side portion 31, and a second side portion 41. As shown in FIG. 3, the cap 200 may be substantially U-shaped. Also as shown in the example embodiment of FIG. 3, the first and second side portions 31 and 41 may be substantially parallel. As shown in FIG. 3, the sheet of metal substrate 230 of the cap 200 may be continuous through the cap. In another embodiment, the metal may be discontinuous through the cap. An exemplary metal used for the sheet of metal substrate 230 may be comprised of steel, such as carbon steel or stainless steel, aluminum, or other similar or suitable metals. The coextruded layer of plastic 220 of the cap 200 may preferably be continuous around the sheet of metal substrate 230 of the cap at 200. The coextruded layer of plastic 220 may preferably be comprised of a durable and lightweight material such as polyvinyl chloride (PVC), polyethylene, polypropylene, or other similar, suitable, or conventional materials. This combination of the sheet of metal substrate 230 and coextruded layer of plastic 220 provides a strong, durable, and lightweight cap 200 as an exemplary embodiment of the present invention.

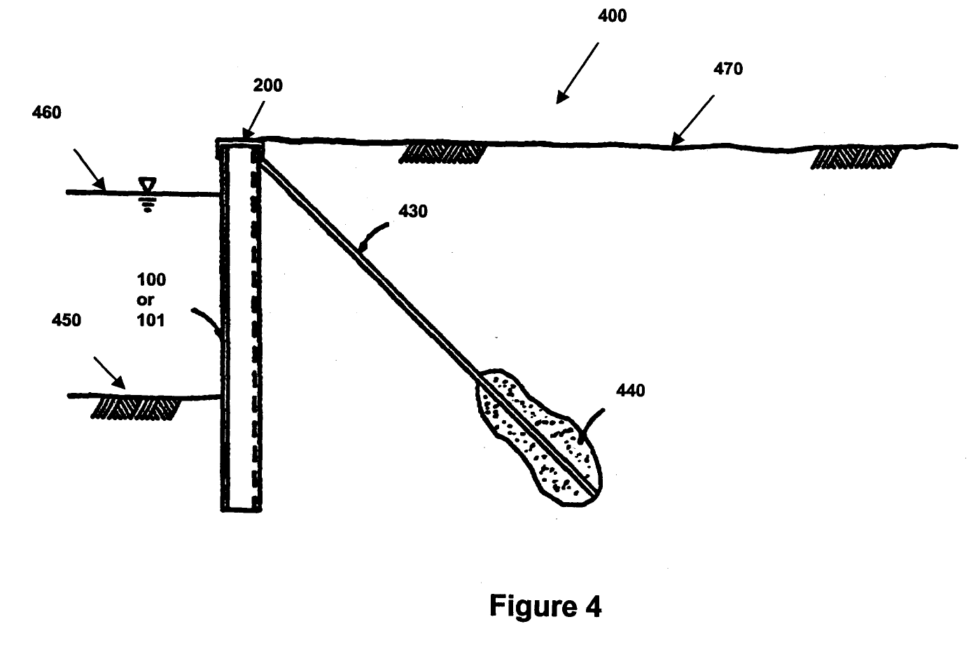

FIG. 4 illustrates a cross-sectional view of an exemplary embodiment 400 of an installation that may utilize an exemplary embodiment of a retaining panel 100 or 101 and cap 200 of the present invention. FIG. 4 shows a side view of the exemplary retaining panel 100 or 101 driven into the soil at 450. The cap 200 is shown covering the upper end of the panel 100 or 101 and serving as the connection point for a tie rod 430 that is in turn connected to an anchor point 440. The connection point between the cap 200 and the tie rod 430 may be a welded connection, a hooked connection, or more commonly, be comprised of the tie rod 430 passing through a portion of the cap 200 and possibly through the upper end of the panel 100 or 101. In this latter means of connection described, the tie rod 430 may then be secured to the cap 200 and panel 100 or 101 by at least a nut engaging a threaded end of the tie rod 430. Elements 460 and 470 of FIG. 4 represent the tops of the water and the fill material, respectively, of a completed installation of the panel 100 or 101 and the cap 200 as part of an exemplary anchored seawall construction.

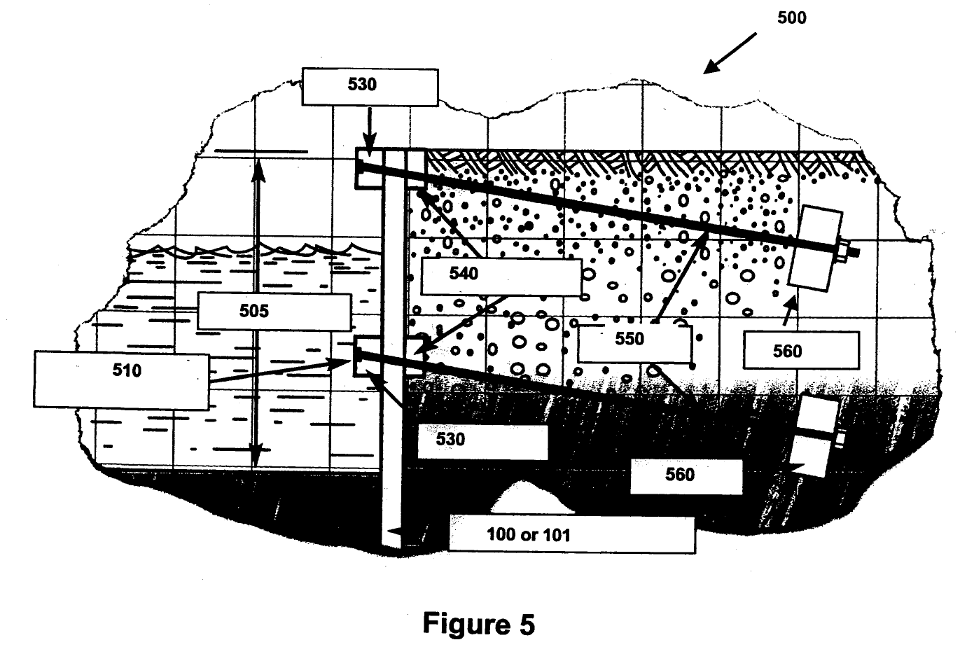

FIG. 5 illustrates a cross-sectional view of an exemplary embodiment of an installation 500 that may utilize an exemplary embodiment of a retaining panel 100 or 101 of the present invention. FIG. 5 shows a side view of the exemplary retaining panel 100 or 101 driven into the soil having an effective height shown at 505. The connection points between the tie rods 550 and the panel 100 or 101 includes front wales 530 and rear wales 540. The connection point between the tie rods 550, front wales 530, rear wales 540 and panel 100 or 101 may be secured by a welded connection or a hooked connection. It is also common for the connection point to be comprised of the tie rod 550 passing through the wales 530 and 540 and the panel 100 or 101 and secured by at least a nut 510 engaging a threaded end of the tie rod 550.

FIGS. 6 through 11 illustrate various perspective, plan, and elevational views of the exemplary embodiments shown in FIGS. 1 and 2.

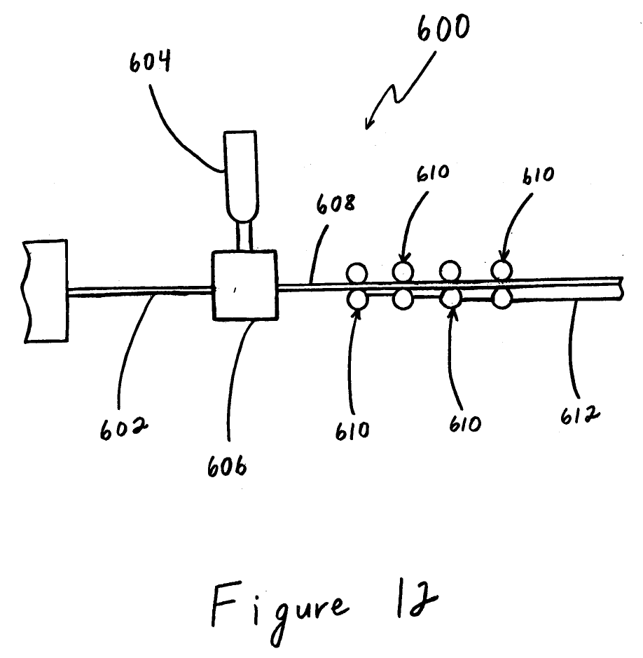

An example of a panel of the present invention may be manufactured by providing or coating plastic on one or more metal sheets. For example, a panel of the present invention may be formed using one or more manufacturing methods including, but not limited to, extrusion, coextrusion, compression molding, injection molding, roll forming, cold forming, hydro forming, and other similar, suitable, or conventional manufacturing techniques. FIG. 12 shows an example of an in-line manufacturing system 600 that may be used to make a panel of the present invention. In this exemplary embodiment, a metal sheet 602 is provided to an extrusion system that processes the plastic. The extrusion system may be comprised of at least one extruder, at least one die, and other suitable extrusion equipment. FIG. 12 shows an extruder 604 and a cross-head die 606 of the exemplary extrusion system. As the metal sheet 602 passes through the die 606, the extruded plastic coats the metal sheet 602. The plastic may coat some or all portions or sides of the metal sheet 602. It should be understood that a tie layer may be provided between the metal sheet and the plastic. Examples of a tie layer include adhesives, epoxies, resins, polymers, and other similar, suitable, or conventional materials that promote the bonding of plastics and metals. The tie layer may be heat activated if desired. One exemplary embodiment of an adhesive is an acrylic/phenolic adhesive that is available from SIA Adhesives. A tie layer may be applied on the metal sheet before it is provided to the extrusion system, or a tie layer may be coated on the metal sheet in the extrusion system. In such instances, it should be understood that the plastic still coats the metal sheet.

In addition to a tie layer, a panel of the present invention may also include a capstock layer. For example, an olefin capstock layer may be provided on the vinyl panel. Examples of olefins include polyolefins such as, but not limited to, chlorinated polyethylene and other similar or suitable olefins. An exemplary embodiment of chlorinated polyethylene is TYRIN® which is available from DuPont Dow Elastomers. The capstock layer may be coextruded with the vinyl layer through die 606. Alternatively, the capstock layer may be coated on the vinyl panel in a subsequent extrusion or molding process. An exemplary embodiment of the olefin capstock layer may offer improved chemical resistance. In addition, an exemplary embodiment of the olefin capstock layer may offer improved impact resistance as well improved heat and flammability resistance. As result, a panel of the present invention having an olefin capstock layer may be ideally suited for forming a wall to contain chemicals, oils, fuels, or other types of environmentally hazardous or harmful materials. For example, a panel of the present invention having an olefin capstock layer may be used to form containment walls around spills or potential spills of environmentally hazardous or harmful materials. Furthermore, an olefin capstock layer may be provided on other types of vinyl components not limited to panels having a metal layer. For instance, an olefin capstock layer may be provided on other types of components (which may or may not include a metal layer) that may be partially or wholly formed from virgin or regrind vinyl material (e.g., PVC regrind which may have a porous surface). Examples of other vinyl components that may benefit from an olefin capstock layer include, but are not limited to, building components, siding, siding accessories, deck components, deck railings, roof components, floor components, wall components, furniture edges, furniture components, interior and exterior decorative house moldings, picture frames, window moldings, window lineals, window components, door components, fence posts, fence rails, fence components, and other suitable indoor and outdoor components. In fact, an olefin capstock layer may be applied on practically any type of extruded or otherwise molded component having a vinyl layer.

In one example of the manufacturing process for a retaining panel, the resulting extrudate 608 may be generally flat except for the distal end portions that form the connectors. However, in other embodiments of the manufacturing process, the resulting extrudate 608 may have some curvature (e.g., if a curved piece of metal is provided to the extrusion system or if multiple pieces of metal are provided to the extrusion system). While the resulting extrudate 608 is at an elevated temperature and not yet set in shape, the extrudate 608 may be passed through a roll forming system. The roll forming system may be comprised of at least one pair of matched forming rolls 610. In this particular example, a series of matched forming rolls 610 progressively bend the extrudate 608 into a finished profile 612 of the panel. Roll forming may be used to produce a profile having a simple angle or a complex profile having multiple bends (e.g., panels as shown in FIGS. 1 through 3).

The exemplary retaining panels 100 and 101 of the present invention may offer one or more of the following benefits: (1) consistent physical properties; (2) a desired strength-to-weight ratio; (3) reduces installation time and costs due to increased width as compared to other retaining panels; (4) effective distribution of loads throughout the panel; (5) interlocking at the rear where stress is lower; (6) U-shape design's higher section modulus allows greater spacing between wales to reduce the number required in certain situations; (7) the strength of the U-shape permits cantilevering in some applications; (8) easy to drive and can be driven one at a time as opposed to Z-shaped panels which may require driving two at a time; (9) little or no rotation during installation; (10) interlocks are not readily visible; (11) interlocking design allows inside or outside curves to follow natural contours; (12) environmentally safe, virtually maintenance free, no need to paint, and impervious to sunlight, saltwater, and marine borers; (13) metal layer increases the modulus of elasticity of the panel, thereby lessening the tendency of an installed panel to creep in position; (14) metal layer enables a panel to be built less deep (from front to back) as compared to a similar panel without a metal layer while maintaining at least the same or greater strength; (15) metal layer increases the impact strength of the panel; and (16) metal layer improves absorption of energy when driven into place by a vibro hammer, thereby facilitating installation.

A retaining panel 100 of the present invention may be made from a variety of materials. In an exemplary embodiment, the sheet of metal substrate 130 may be comprised of a metallic material such as steel, aluminum, or other similar or suitable metals, while the coextruded layer of plastic 120 may be comprised of a plastic material such as polyvinyl chloride (PVC), polyethylene, polypropylene, or other similar, suitable, or conventional materials. The outer plastic material layer preferably prevents and/or withstands heat, cold, pressure exerted by the water, pressure exerted by the land, corrosion, and sunlight. The combination of a metallic inner layer and a plastic outer layer also preferably makes a retaining panel 100 of the present invention relatively lightweight, easy to install, and easy to repair or replace, while being strong and durable. In addition, conventional extrusion or molding processes may be utilized to form the coextruded layer of plastic 120 onto the sheet of metal substrate 130 of a retaining panel 100 of the present invention.

Metal is only one example of a material that is suitable for use as a substrate in the present invention. The substrate may be made from any material that has more bending strength or rigidity than the material used to make the outer layer. In other words, a piece of the material used for the substrate has a higher bending strength or rigidity than a comparable size piece of the material used for the outer layer. Fiberglass is one example of a material that may be used as a substrate in the present invention. Other examples of materials that may be used as a substrate include, but are not limited to, wood, wood composites, plastic composites (such as, but not limited to, inorganic-filled plastic composites and cellulosic-filled plastic composites), plastics, glass, concrete, other types building or construction materials, and any other similar or suitable material that has a higher bending strength or rigidity than the material used for the outer layer.

A plastic or plastic composite substrate may be made using conventional manufacturing techniques and be coextruded with the other layer(s) of the panel. For instance, a flexible plastic composite (with or without inorganic or cellulosic fillers) may have a higher bending strength than the material used to make the outer layer. One embodiment of a flexible plastic composite is a composition comprised of at least one cellulosic filler and a plastic substance. The plastic substance may be comprised of a thermoplastic elastomer and/or a melt-processible rubber. Alternatively, the plastic substance may be comprised of a non-thermoplastic elastomer, e.g., an elastomer that includes a thermosetting material. Examples of a thermoplastic elastomer include, but are not limited to, flexible PVC, polyolefin elastomers, thermoplastic olefins, thermoplastic urethanes, thermoplastic rubbers, and other similar, suitable, or conventional elastomer materials. Examples of polyolefin elastomers include chlorinated polyethylene and ENGAGE™ polyolefin elastomer. ENGAGE™ polyolefin elastomer is commercially available from DuPont Dow Elastomers L.L.C. An example of thermoplastic rubber is SANTOPRENE™ thermoplastic rubber, which is commercially available from Advanced Elastomer Systems. Furthermore, examples of melt-processible rubber include ALCRYN™ melt-processible rubber and other similar, suitable, or conventional materials. ALCRYN™ melt-processible rubber is commercially available from Advanced Polymer Alloys, LLC.

The plastic substance of the flexible plastic composition may optionally include other ingredients. In one exemplary embodiment, the plastic substance further includes at least one stabilizer, at least one lubricant, and at least one process aid. An example of a process aid is a fatty acid such as stearic acid and other similar, suitable, or conventional acids.

The amounts of the various ingredients of a flexible plastic composition may be chosen to achieve the desired characteristics of the composition. In one exemplary embodiment, the cellulosic filler is present in an amount less than about 75% by weight of the composition, more preferably between about 20% and about 55% by weight of the composition, and still more preferably between about 25% and about 50% by weight of the composition. On the other hand, the plastic substance preferably accounts for at least about 25% by weight of the composition, more preferably between about 45% and about 80% by weight of the composition, and still more preferably between about 50% and about 75% by weight of the composition. More particularly, the plastic substance of one exemplary embodiment is comprised of: (a) a material selected from the group consisting of thermoplastic elastomers, melt-processible rubbers, and non-thermoplastic elastomers; (b) at least one stabilizer in a total amount of about 0.5 to about 2.5 parts per 100 parts of the material of (a); (c) at least one lubricant in a total amount of about 0.5 to about 2.0 parts per 100 parts of the material of (a); and (d) at least one process aid in an amount of about 0.3 to about 1.5 parts per 100 parts of the material of (a).

Another example of a material that may be suitable for use as a substrate is a cellulosic/PVC composite material. This example of a composite material may include at least one cellulosic filler in the amount of about 15% to about 35% by weight, more preferably about 20% to about 30% by weight. The composite may also include a PVC material in the amount of about 65% to about 85% by weight, more preferably about 70% to about 80% by weight.

The PVC material may include PVC resin in an amount of about 20 to about 70% by weight of the composite material, more preferably about 30 to about 60% by weight of the composite material, still more preferably about 40 to about 50% by weight of the composite material. In an exemplary embodiment, the inherent viscosity of the PVC resin may be between about 0.6 and 1.1 and more preferably between about 0.7 and 0.9. The PVC material may also include chlorinate polyethylene (CPE) in an amount of 0 to about 40% by weight of the composite material, more preferably about 5 to about 30% by weight of the composite material, still more preferably about 10 to about 20% by weight of the composite material. Stabilizer(s) may also be included in an amount of about 0.5 to about 4% by weight of the composite material, more preferably about 1 to about 3% by weight of the composite material. The lubricant(s) may be present in an amount of about 1 to about 8% by weight of the composite material, more preferably about 2.5 to about 5% by weight of the composite material. The process aid(s) may be included in an amount of about 0.5 to about 5% by weight of the composite material, more preferably about 1 to about 3% by weight of the composite material. Also, the PVC material may include an inorganic filler in an amount of 0 to about 15% by weight of the composite material, more preferably about 2 to about 10% by weight of the composite material.

Although some exemplary plastic composites are set forth above, other plastic composites may also be used in the present invention. Furthermore, any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

We claim:

1. A method of manufacturing a panel, said method comprising:
providing a metal sheet to an extrusion system;
extruding a plastic on said metal sheet to form an extrudate; and
roll forming said extrudate into a final shape of said panel.

2. The method of claim 1 wherein said extrusion system comprises at least one die.

3. The method of claim 1 wherein said metal sheet is comprised of a metal selected from the group consisting of steel and aluminum.

4. The method of claim 1 wherein said metal sheet is flat when applied to said extrusion system.

5. The method of claim 1 wherein said plastic comprises polyvinyl chloride.

6. The method of claim 1 wherein said plastic is a plastic composite.

7. The method of claim 6 wherein said plastic composite comprises a cellulosic filler.

8. The method of claim 6 wherein said plastic composite comprises an inorganic filler.

9. The method of claim 1 wherein said panel comprises:
a central portion having a first end portion and a second end portion;
a first side portion extending rearwardly from said first end portion of said central portion; and
a second side portion extending rearwardly from said second end portion of said central portion.

10. The method of claim 9 wherein said panel further comprises:
a first flange extending from a rear end portion of said first side portion; and
a second flange extending from a rear end portion of said second side portion.

11. The method of claim 10 wherein:
a distal portion of said first flange comprises a female connecting portion; and
a distal portion of said second flange comprises a male connecting portion.

12. A method of manufacturing a panel, said method comprising:
providing a flat metal sheet;
extruding a plastic on all sides of said metal sheet to form an extrudate; and
roll forming said extrudate into said panel, said panel having a generally U-shaped portion.

13. The method of claim 12 wherein said metal sheet is comprised of a metal selected from the group consisting of steel and aluminum.

14. The method of claim 12 wherein said plastic comprises polyvinyl chloride.

15. The method of claim 12 wherein said plastic is a plastic composite.

16. The method of claim 15 wherein said plastic composite comprises a cellulosic filler.

17. The method of claim 15 wherein said plastic composite comprises an inorganic filler.

18. A method of manufacturing a panel, said method comprising:
providing a flat metal sheet;
coating a plastic on all sides of said metal sheet; and
roll forming said metal sheet such that a final shape of said panel is formed, said panel having a generally U-shaped portion.

19. The method of claim 18 wherein said panel is a seawall panel.

20. The method of claim 18 wherein plastic is coated on said metal sheet by extrusion.
